(19) United States
(12) Patent Application Publication
(10) Pub. No.: US 2009/0064339 A1
(43) Pub. Date: Mar. 5, 2009

(54) SYSTEM AND METHOD FOR AUDIT GOVERNANCE IN EMAIL

(76) Inventors: Gary Denner, Kildare (IE); Ruthie D. Lyle, Durham, NC (US); Patrick J. O'Sullivan, Dublin (IE); Carol S. Zimmet, Boxborough, MA (US)

Correspondence Address: HOFFMAN WARNICK LLC, 75 STATE STREET, 14TH FLOOR, ALBANY, NY, 12207, US

(21) Appl. No.: 11/847,392

(22) Filed: Aug. 30, 2007

(51) Int. Cl. G06F 21/00; G06F 15/16

(52) U.S. Cl. 726/26; 709/206

(57) ABSTRACT

A system and method, where messages which are exchanged in email, provide recipients (and originators) with the capability to confirm authenticity. A substring of a message is examined, is validated and, if any modifications have been made, the modifications are highlighted to the originator and the receivers so that the originator and the receivers know that the original message has been modified. Also, the system and method of the present invention preserve the time, date and identity of the maker of the modifications.

### FIELD OF THE INVENTION

The present invention relates generally to email systems and, more specifically, to a system and method for governing email systems using audits.

### BACKGROUND OF THE INVENTION

Situations can arise where one individual receives an email from another individual, and, prior to forwarding this email, may decide to adapt the message (a little or a lot) in a way that alters the outset intention or meaning (a little or a lot). This message may be forwarded to other individuals (as a conventional forward or as a DNC (do not copy) forward) where the altered meaning is digested. The same message may be propagated in turn to other users or modified by others to whom it is propagated. Adaptation of the original message may place emphasis on a part(s) such as by underlining or bolding, for instance, may make slight changes, such as by removing/adding words/sentences, by making significant doctoring that fraudulently alters the original intention or meaning. Situations can easily arise where such activity happens unaware to the owner of the original message.

There is a present need to govern the changes to email content.

Conventional art provides solutions around signatures and exchange credentials that allow a sender and recipient to confirm authenticity, however conventional solutions do not address the problem of alteration in propagation in whole or in part. Specifically, conventional art falls short in audit remediation capabilities.

Lack of formal capabilities to validate content that is propagated in email presents audit control problems that are most prevalent in security, financial and corporate circles. Audit compliance to ISO standards requires controls be put in place to circumvent shortfalls in conventional art. (The International Organization for Standardization (ISO) is an international standard-setting body composed of representatives from various national standards bodies. The organization produces world-wide industrial and commercial standards.) Specifically, the inclusion of electronic content in a repository is not deemed audit compliant, oftentimes this needs to be associated and accompanied with paper copies that are stamped/authenticated, providing a secondary validation point to secure audit compliance. Measures to relate and validate content in this way are pervasive in audit sensitive environments, are time consuming and labor/space intensive.

Expensive approaches that exploit workflow based systems to achieve the desired audit governorship are time consuming, system dependent and expensive. There is a need for a system and method for exploiting extension points that exist in the current Mail RFC and tying the proposed solution to existing email systems and methods and preserving autonomy. (Request for Comments (RFC) documents are a series of memoranda encompassing new research, innovations, and methodologies applicable to Internet technologies.)

### BRIEF SUMMARY OF THE INVENTION

The present invention is system and method where messages, which are exchanged, sometimes in email format, provide recipients (and originators) with the capability to confirm authenticity. Specifically, present invention is system and method utilizes electronic capabilities to arbitrarily assess the authenticity of a message that has been propagated in real time is the centripetal contribution to knowledge. The system and method of the present invention provide substring validation—where some of the content has been removed while the remaining content is preserved (for example, a user may remove a line that is controversial)—and where the message would need to pass authenticity checks for the parts present but highlight to the originator and/or the recipients that content was removed or otherwise modified.

The system and method of the present invention further allows a user, who is the owner of a message, to be able to validate the authenticity of this message regardless to whom it has been propagated to. The system allows the owner of the message to ensure that the communication expressed is preserved for the audience intended, as well as the audience that benefit from further propagation (regardless of whether the seminal owner is copied or not). Further, the system and method of the present invention provides the seminal, or original, owner of a message to achieve knowledge of any change made to her message, to include when this happened, who made the alteration, what the alteration was, and who consumed the alteration. The seminal owner benefits from the knowledge that can motivate the relevant correction process if she deems warranted—while at the same time respecting the peripheral content associated with same (which would not (conventionally) be an entitlement).

In the preferred embodiment, there an audit semantic is associated with email messages that are flagged as audit-validated, such that this is a preference an administrator can apply to a broader messaging infrastructure, or a user can select to convey to consumers that audit checks are in place to confirm audit conformance for all instances of the message, included when same is propagated.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 depicts the system of the present invention.

FIG. 1A illustrates the email system of the present system.

FIG. 2 represents an embodiment of a method of the present invention.

FIG. 3 represents further detail of the preferred embodiment of a method of the present invention.

The drawings are intended to depict only typical aspects of the invention, and therefore should not be considered as limiting the scope of the invention. In the drawings, like numbering represent like elements between the drawings.

### DETAILED DESCRIPTION OF THE PREFERRED EMBODIMENT OF THE PRESENT INVENTION

The present invention provides system and method for governing email systems using audits.

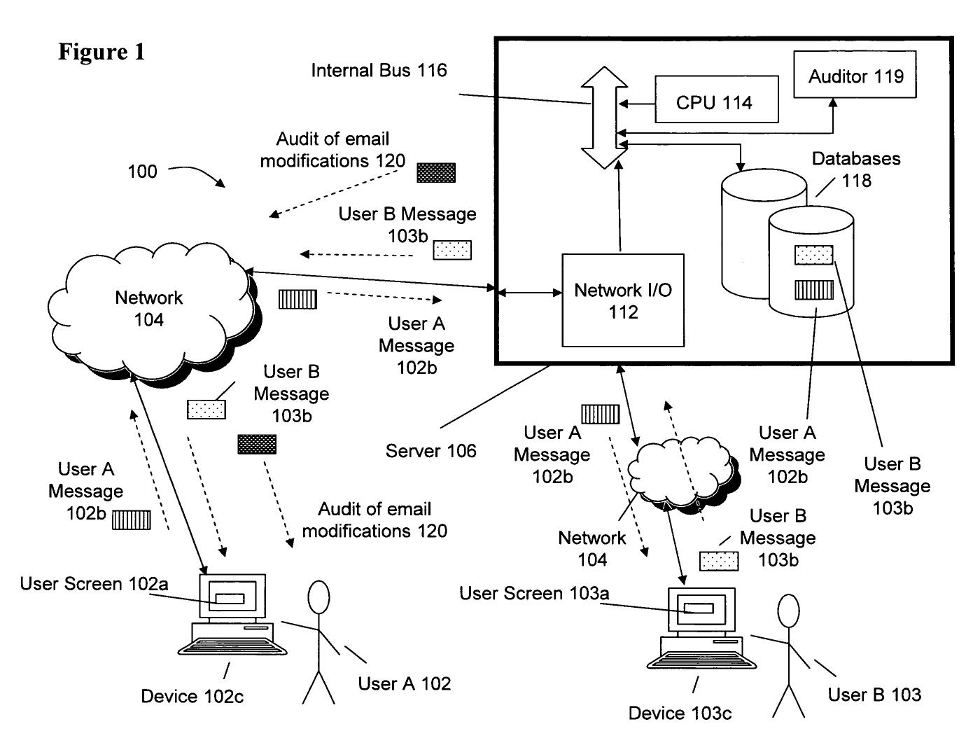

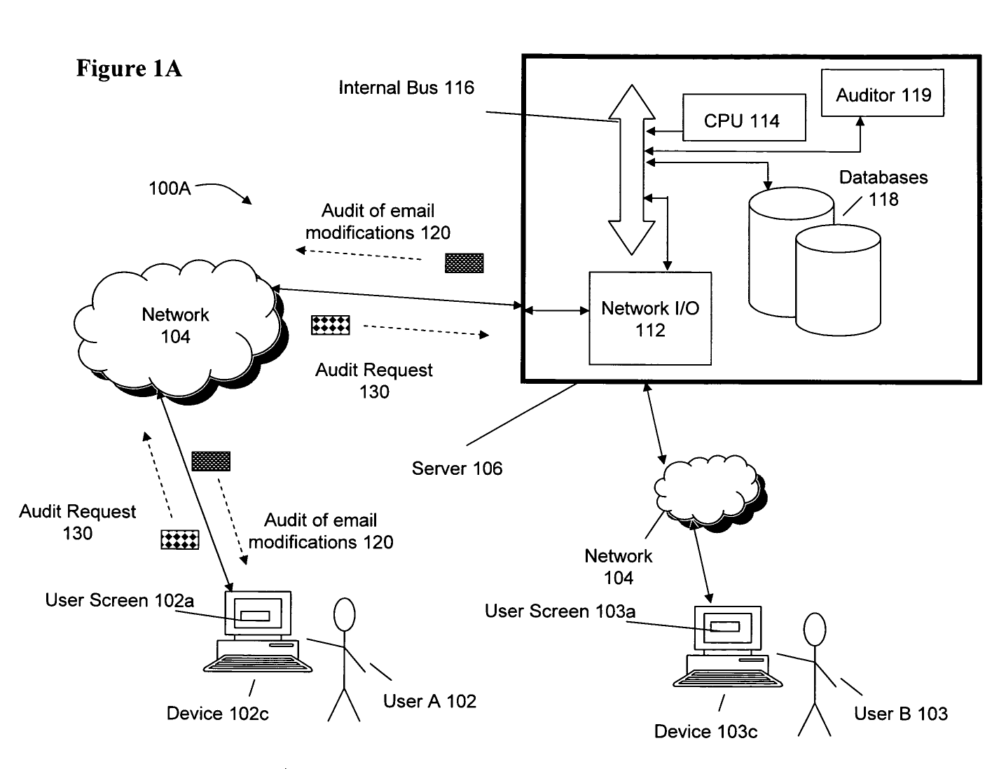

FIG. 1 illustrates the email system 100 of the present invention. User A 102 wishes to communicate with User B 103. Instead of phoning, User A 102 (“Originator”) uses email and sends an original email (“User A Message 102b) to communicate with User B 103 or other users (“Recipients”). The email system allows User A's and User B's screens 102a, 103a to illustrate the email thread (or string of emails) between User A 102 and User B 103 (and other users possibly). Email messaging requires an email client such as IBM's Lotus Notes® (see http://www-142.ibm.com/software/sw-lotus/products/product4.nsf/wdocs/noteshomepage), generally installed on a general purpose computer (see http://computer.howstuffworks.com/pc.htzxswe34m) which has a communications device that connects to an email server 106 via network 104. (However, the Devices 102c, 103c don't need to be personal computers as they can as easily be cell phones, PDAs and the like.) Like many servers, Server 106 has a network input/output device 112 to receive and send messages, one or more CPUs 114, databases 118 to store email thread and IM messages and other data related to conversation sessions, and an internal bus 116 like other computers. User A Message 102b is stored in Databases 118 and is forwarded to User B 103 to be displayed on Device 103c on User B's Screen 103a.

However, the original message (“User A Message 102b) can be modified User B 103 or others (“Recipients”) and forwarded on. Using the system and method of the present invention, the Originator has the ability to “tag” the original email, or message, and in so doing automatic associates the saved CRC values against each of the mail semantics (from the “To”, “From”, “CC”, “BCC”, “Subject”, “Body”, etc., fields of an email message) in such a way that if any of these changed in the act of propagation (“Reply”, “Forward”, etc.), the Originator can be notified. Likewise, an ability is provided to the Recipients to appreciate that the mail that they have received is exactly what was sent by the Originator.

Auditor 119 monitors the changes made to the original email (“User A Message 102b) sent from the originator by the receivers or even by the originator. The changes are tracked by Auditor 119 and stored in Databases 118. Alternatively, the changes can be stored in a cache. When the originator, User 102 A “Originator”, requests an audit of the changes, the changes are forwarded by the Auditor 119 to the originating emailer as an audit notice of email modifications 120.

FIG. 1A illustrates the email system 100A of the present system. After User A 102 (“Originator”) sends an email to User B 103 and others (“Recipients”) as per FIG. 1, User A 102 (“Originator”) wishes to receive an audit of the changes made to the original email (User A Message 102b) so she sends an audit request (Audit Request 130) to Server 106. Audit Request 130 is processed by Server 106 and passed to Auditor 119. The changes to the original email (User A Message 102b), which have been stored in Databases 118, are passed back to User A 102 (“Originator”) as an Audit Notice of Email Modifications 120.

The system and method of the present invention provides a combination of a revised user interface (“UI”) which allows additional flags in the email to communicate an audit semantic to one or more individuals receiving the email. This is expressed on the Originator side and is communicated passively on the Recipient side.) The original email is conveyed to the Recipients and system and method of the present invention utilize the conventional email RFCs, in so doing, the extension points that exist in the RFCs are used to store the additional (silent) information that communicates the audit semantics. [Question to inventors: could you provide the RFC number and extension points which your invention is utilizing? I couldn't find it in the documents I received. Is it one of these? I am guessing the last one. [symbol]
RFC 821 (Simple Mail Transfer Protocol)
RFC 822 (Internet Mail Header Format)
RFC 1123 (Internet Host Requirements)
RFC 1869 (SMTP Service Extensions)
RFC 1891 (SMTP Delivery Status Notifications)
RFC 1892 (Multipart/Report)
RFC 1893 (Mail System Status Codes)
RFC 1894 (Delivery Status Notifications)
RFC 1985 (SMTP Service Extension for Remote Message Queue Starting)
RFC 2034 (SMTP Service Extension for Returning Enhanced Error Codes)
RFC 2045 (MIME) Mime Types List
RFC 2476 (Message Submission)
RFC 2554 (SMTP Service Extension for Authentication)] On the client side, the local mail system, such as IBM's Lotus Notes® collaboration client, parses the extension points as well as the accompanying email to achieve the desired audit compliance goal.

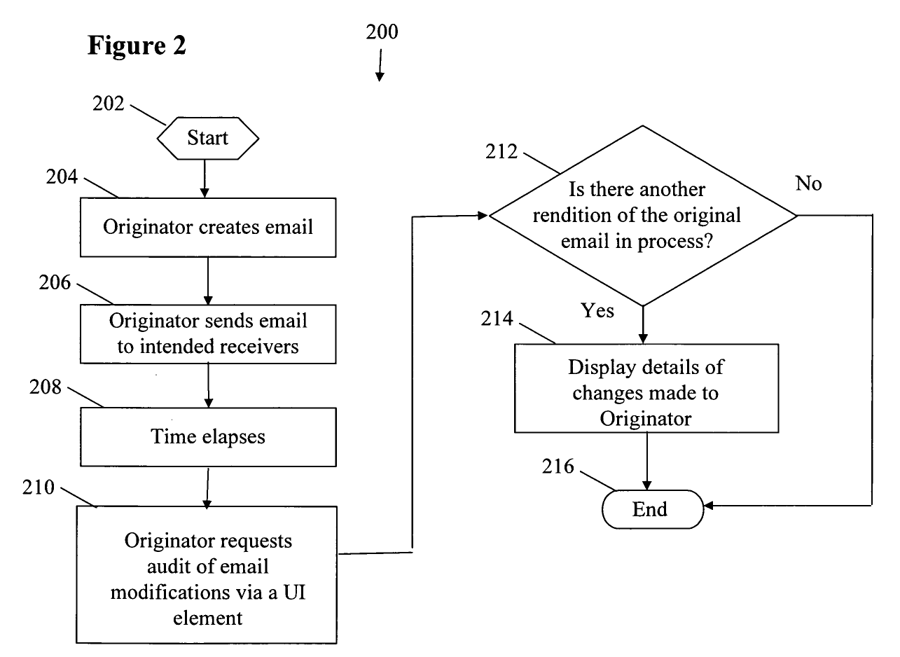

The method 200 of the present invention is shown in FIG. 2 which starts at step 202 and continues to step 204 where an originator creates an email. At step 206, the originator sends the email to one or more intended receivers. At step 208, time elapses. At step 210, the originator requests an audit of the email modifications. At step 212, the system determines whether there is another rendition of the email in process. If not, the method ends at 216. If so, at step 214, the details of the changes are displayed to the originator and the method/process ends at 216.

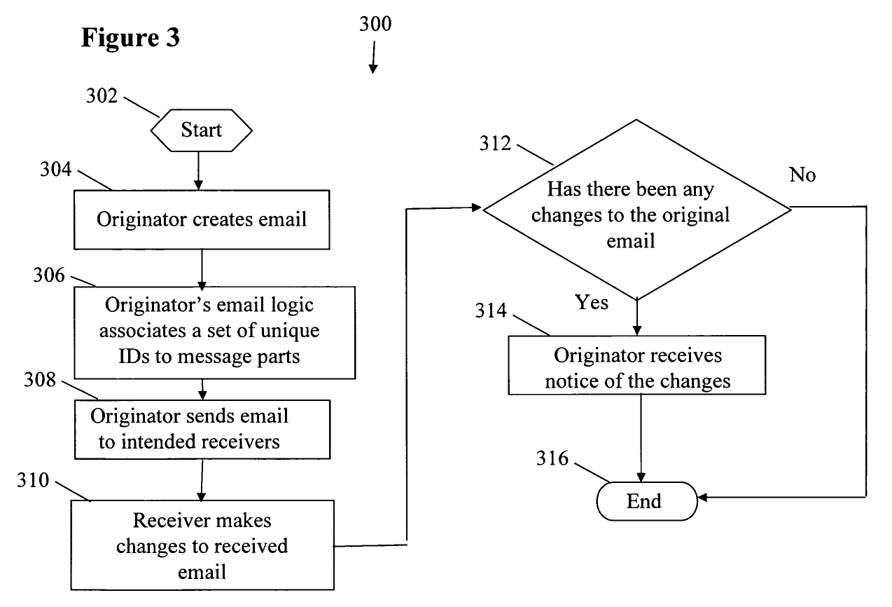

The method 300 of the present invention is further shown in FIG. 3 which starts at step 302 and continues to step 304 where an Originator creates an email. At step 306, the Originator's email client's logic associates a set of unique IDs to message parts sends the email to one or more intended Recipients. At step 308, the Originator sends email to intended Recipients and, at step 310, one or more of the Recipients makes changes to received email. At step 312, the system determines whether the original email has been modified or changed. If not, the method or process ends at step 316. If so, the Originator is notified (whether through a direct request or through an indirect notice) of the email modifications and the method or process ends at step 316.

The system and method of the present invention works by associating a set of unique IDs (based on a hash of a combination of message semantics formed by intelligent aggregation of message parts (e.g., “To”, “CC”, “Subject” and “Body” fields) to yield a set of unique values or keys that are permanently associated with the message—e.g., a 128 bit CRC. (A hash function is a reproducible method of turning some kind of data into a (relatively) small number that may serve as a digital “fingerprint” of the data. The algorithm “chops and mixes” (i.e., substitutes or transposes) the data to create such fingerprints. The fingerprints are called hash sums, hash values, hash codes or simply hashes. (Note that hashes can also mean the hash functions.) Hash sums are commonly used as indices into hash tables or hash files. Cryptographic hash functions are used for various purposes in information security applications. A cyclic redundancy check (CRC) is a type of function that takes as input a data stream of unlimited length and produces as output a value of a certain fixed size. The term CRC is often used to denote either the function or the function's output. A CRC can be used in the same way as a checksum to detect accidental alteration of data during transmission or storage. CRCs are popular because they are simple to implement in binary hardware, are easy to analyze mathematically, and are particularly good at detecting common errors caused by noise in transmission channels.) The RFC provides capabilities to abstract such fields, thereby providing the capability to hash. The propagation of the message would include the propagation of the CRC. On receipt of this message, the rendering client (Originator or Receiver) can validate the integrity of the message received against the associated CRC. Integrity is immediately confirmed or denied. In the preferred embodiment of the present invention, the unique CRC is protocol sensitive—such that in instances where formatting changes due to transcoding for protocol transmission then the message integrity is based on a protocol neutral hash value (e.g., where rich text semantics are lost in communication the textual message still passes audit validation). Respectively, a plurality of CRCs are associated with the message, where each CRC respect the various protocols and formats that the message may be transcoded to, such that on receipt the ultimate message received is validated with sensitivity to the protocol used to transmit.

In a simpler embodiment, this CRC is associated with the seminal message that lives in the Originator's mailbox and audit is confirmed based on a pair-based relationship that is executed at run/display time (e.g., AJAX or a web services request). (AJAX is a web development technique used for creating interactive web applications. The intent is to make web pages feel more responsive by exchanging small amounts of data with the server behind the scenes, so that the entire web page does not have to be reloaded each time the user requests a change. This is intended to increase the web page's interactivity, speed, functionality, and usability.)

In the embodiment a UI semantic exists for the receiver of an email to validate the integrity of what is received as compliant with what was sent.

Associated with each message (as described) are the audit hash values which in turn map an associated URI (a Uniform Resource Identifier (URI), is a compact string of characters used to identify or name a resource. The main purpose of this identification is to enable interaction with representations of the resource over a network, typically the World Wide Web, using specific protocols. URIs are defined in schemes defining a specific syntax and associated protocols.) to a data store that records the seminal, or original message. In the preferred embodiment, the data store provides a web services interface that permits audit validation. (The W3C defines a web service as a software system designed to support interoperable machine to machine interaction over a network. Web services are frequently just Web APIs that can be accessed over a network and executed on a remote system hosting the requested services.) The recipient client, such as the IBM® Lotus Notes client, interfaces with the web services and the message received is automatically validated (on user request or otherwise) for integrity. In the preferred embodiment, the CRCs and URI are communicated and a Boolean value is returned to confirm compliance.

In another embodiment, the CRCs and URI are communicated and intelligent pattern matching of each mail part (relative to RCF semantics) are validated, returning (in the preferred embodiment) the exact nature of any disparity for any of the mail entities (based on RFC).

In the preferred embodiment, the mail router respects the audit flag and audit semantics by (where relevant) routing the message delivered first to the audit store, and second to the intended recipients. Parameters which establish audit compliance are encapsulated in the mail delivery subsystem on the basis that this is the centripetal point of routing.

The central store maintains a history inventory that tracks the propagation of the seminal mail. Such a system requires (in the preferred embodiment) the association of a preference with the seminal mail for this purpose of same, or a broader (or indeed selective) configuration choice by the administrator to enforce this as an infrastructural policy. The same web services interface described above allows the seminal owner of a message to invoke (on the message sent) the knowledge of where the mail was sent (including initial, secondary, tertiary extrapolations), identities propagated to, authenticity on each entity propagated, and knowledge of any audit anomalies (which in turn furnish answer where/when/who/what knowledge).

Emails that contain multiple emails (threads) have start and end delineators embedded in the message (exploiting extensions in RFCs to note start and end) such that the granularity of audit compliance can live with individual messages that comprise a thread in one instance of a message. Likewise, the entire thread, in the preferred embodiment, can represent a uniquely discernible audit validation point (e.g., John sends a lengthy thread to Mary, John wants Mary to ensure that the entire thread is singularly auditable, as the content of the entire thread is deemed as needing audit ensured).

Mail RFCs are specific in allowing the system the capability of establishing start and end delimiters associated with an email. Included in the RFCs are attributes associated with the message—so semantics like “To”, “From”, “CC”, “BCC”, “Subject”, “Body”, attachments and so on. These can be independently discerned. This, in essence, provides the system and method of the present invention a capability the ability to keep track of how they mature as messages propagate (forward, reply, etc). Identifying a hash value (e.g., 128 bit CRC) against these RFC semantics/values allows the system (in a byte light/insignificant way) to establish changes. For instance, in a system where one user (originator—User 1) sends a mail to one or more other users (recipients—User 2) with some content, User 1 may select a UI box to maintain/track mail integrity, as she wants the message that she sent to stay in its exact/original form. A record is stored on the server, includes a hash of each of these fields and optionally (configuration choice) a pointer to a clone/copy of the message for exact comparison (if required later). The present invention provides the ability to highlight change beyond the originator, but also the ability to highlight “where” the change occurred if desired. User 2 forwards this message to User 3. Conventional Start and End delimiters associated with the new body field (which contains an entire mail) are used to establish the content of User 1's message in what User 2 is forwarding. Parsing out the attributes (e.g., “To”, “From”, “CC”, “Bcc”, “Subject”, “Body”, “Attachments”) is a simple matter.

The system and method of the present invention utilizes the structured form of the email message being forwarded to embed it in the body of the new mail message. It also retains a notion of that structure within the unstructured body, as a structured email essentially becomes unstructured when included in the body of a mail, which essentially describe an unstructured field.

The knowledge that the body of the unstructured field holds structured content is given to the system in the act of propagation. For example, in a reply-with-history to a single mail, the system can establish (based on the act of reply) that the unstructured content has a mail. That is likewise for the mail forwarding aspect. An alternative is basic parsing that can establish a structure from unstructured content based on basic parsing to satisfy a premise. For example, the system can assert that an unstructured field has a structured email and parse for the semantics associated with the structured content—essentially allowing the system to pull out the key fields like “Date”, “From”, “To”, “CC”, “Bcc”, “Subject, “Body” and relate a CRC individually to these. However, if the system only relies on re-parsing, and if each field that is tracked is changed, then the system can't string together the history of the original mail message. Therefore the addition of a unique ID for tracking is needed in extreme cases where there is substantial change. In this regard, the system utilizes an archive of the seminal mail in a central place if it ever needs it. In situations where there is radical change to every single field (“Date”, “From”, “To”, “CC”, “Bcc”, “Subject, “Body”, “Attachments”) but the system can still keep this honest, as within the unstructured field is data against the fields that are associated with these values. However, in instances where there is radical change a unique ID is pertinent.

The extension points in the RFC are exploited for describing the structure of the message. The system utilizes the knowledge that the unstructured field contains a structured form following propagation and embeds information in these extension points that effectively provides hash values against the fields the administrator deems significant. At the point, where the mail is sent, the system can determine start and end offsets for the structured content in the unstructured field (as the system has a complete payload at the point of send for the MTA). Relating the content to a pattern (which essentially an email is) would make this more efficient, but would still involve some parsing.

The offsets the system can also be provided by the client process that inserted the structured information into the unstructured field. Those offsets can be rendered incorrect during user editing. However, offsets are not completely necessary in the typical use cases and these can be derived at any time. A structured content in an unstructured field benefits from delimiters that are associated with each field. For example, the body text of an unstructured field implements the email pattern (a pattern the system knows as it has been defined) in reply and forward—this happened by default. Because it happens by default, the system can relate to this pattern and parse against it. Within this pattern some basic parsing can pick off the significant components (essentially assumptions of structure in fields that are unstructured). These offsets can also be rendered by the client process that inserted the structured information, but this is not mandatory in a preferred embodiment—so long as the system has a pattern the system can relate to. For field level precision and radical change, the system flags the whole email as dirty (changed) or relate to the original, or seminal, mail that the system has archived to qualify what exactly has changed.

In the preferred embodiment, emails or other messages, which are tagged route as normal, the receiver benefits from hidden values that store CRC values which are, in turn, related to the content (fields) of the email that they have received. For a single mail (as in a response), the CRCs can be used to confirm that all fields are consistent with the seminal, or original, mail. For a mail that comprises multiple messages or emails in the body (unstructured) field, a linked list is needed. Likewise, in the preferred embodiment, a copy of the seminal mail lives (stored) on a server. CRCs that don't “balance” then allow the system to flag fields that have changed.

The system also tracks subsumed mails that have changed with some sort of identifier. In the preferred embodiment, the emails are date and time stamped as being significant values in furnishing a unique ID along with the “from value”.

Establishing the difference between edited out fields and modified fields is also straightforward. Edited out fields and modified fields pretty much amount of the same end result—the system simply flags the change and, if the change is bad, the system alerts recipients or the originator of the change. Without the storing of the seminal mail, the system can not highlight, with precision, the part that was edited/changed. With a copy of the seminal mail, the system can then do intelligent differencing—as the system has the changed mail, and the original mail.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A system, for allowing an exchange of an original message from a first user (originator) and at least one other user (recipient), for providing recipients and the originator with the capability to confirm authenticity of the original email, and for assessing the authenticity of a message, the system comprising:
a. a network input/output device for receiving a message, from an originator intended to be sent to recipients, to be passed to the recipients, and for passing the message to the recipients;
b. a central processing unit for processing the message;
c. at least one database for storing the message; and
d. an auditor for identifying changes made to the original message and for storing the changes in the at least one database.

2. The system of claim 1 wherein the system receives a tag on the original message from the originator receiving an audit request from the originator.

3. The system of claim 1 wherein the system associates the CRC values with the original message semantics so that if any of these changed in the act of propagation (“Reply”, “Forward”, etc.), the originator can be notified.

4. The system of claim 1 wherein the system examines substrings of the message and validates the substrings to identify if content has been changed while the remaining content is preserved and notifying the originator that the content has been modified.

5. A method, in a system where an original message is exchanged between a first user (originator) and at least one other user (recipient), and subsequently modified, for providing recipients and the originator with the capability to confirm authenticity of the original message, the method comprising the steps of:
a. receiving the original message from an originator;
b. passing the original message to at least one recipient;
c. determining whether another rendition has been created by the at least one recipient of the original message;
1. if so, displaying the changes made to the original message to the originator;
2. if not, indicating to the originator that no changes have been made.

6. The method of claim 5 further comprising the steps of receiving a tag on the original message from the originator receiving an audit request from the originator.

7. The method of claim 5 further comprising the step of associating the CRC values with the original message semantics so that if any of these changed in the act of propagation (“Reply”, “Forward”, etc.), the originator can be notified.

8. The method of claim 5 comprising the step of validating substrings to identify if content has been changed while the remaining content is preserved and where this would pass authenticity checks for the parts present but highlight the knowledge that content was removed relative to this validation.

9. The method of claim 5 further comprising the step of notifying the originator as to when the new rendition was created, who created the new rendition, what alteration was made to the original message, and who consumed the altered message.

10. The method of claim 5 further comprising the step of the originator conveying to consumers that audit checks are in place to confirm audit conformance for all instances of the original message.

11. The method of claim 5 comprising the step of hashing a combination of message semantics formed by intelligent aggregation of message parts, such as the “To”, “CC”, “Subject” and “Body” fields, to yield a set of unique values or keys that are permanently associated with the message, so that the Recipient or Originator can validate the integrity of the message received against the associated CRC.

12. The method of claim 5 wherein the system has storage and the storage maintains a history inventory that tracks the propagation of the original message.

13. The method of claim 5 wherein the system has storage and the storage maintains a history inventory that tracks the propagation of the original message.

14. The method of claim 5 further comprising the step of notifying the originator when a modified message is sent.

15. The method of claim 5 further comprising the step of notifying the originator when a message is modified to allow the originator to review before it is distributed.

16. The method of claim 5 further comprising the step of notifying the originator in real time when a message is being modified.

17. The method of claim 5 further comprising the step of permanently associating the originator with her email such that all propagations from the original message route to the originator.

18. A computer program product in a computer readable medium for operating in a system comprising a network I/O, a CPU, and one or more databases, for implementing a method for governing email systems using audits where an original message is exchanged between a first user (originator) and at least one other user (recipient), and subsequently modified, computer program product for operating a method for providing recipients and the originator with the capability to confirm authenticity of the original message, the method comprising the steps of:
a. receiving the original message from an originator;
b. passing the original message to at least one recipient;
c. determining whether another rendition has been created by the at least one recipient of the original message;
1. if so, displaying the changes made to the original message to the originator;
2. if not, indicating to the originator that no changes have been made.

19. The computer program product of claim 18 wherein the method further comprises the steps of receiving a tag on the original message from the originator receiving an audit request from the originator.

20. The computer program product of claim 18 wherein the method further comprises the step of associating the CRC values with the original message semantics so that if any of these changed in the act of propagation (“Reply”, “Forward”, etc.), the originator can be notified.
